(19) United States
(12) Patent Application Publication
(10) Pub. No.: US 2011/0079545 A1
(43) Pub. Date: Apr. 7, 2011

(54) SHEET SORTING AND STORING APPARATUS AND SHEET SORTING AND STORING METHOD

(75) Inventor: Ryota Saeki, Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/872,108

(22) Filed: Aug. 31, 2010

Related U.S. Application Data
(60) Provisional application No. 61/248,608, filed on Oct. 5, 2009.

(51) Int. Cl. B07C 5/34

(52) U.S. Cl. 209/552

(57) ABSTRACT

According to one embodiment, a sheet sorting and storing apparatus includes: an ID recognizing unit configured to recognize a user ID for identifying a user; a sheet storing unit including plural reuse sheet storing spaces each provided to correspond to the user ID recognized by the ID recognizing unit; a sheet inserting unit into which a sheet is inserted; a printing detecting unit configured to detect whether a front side and a rear side of the sheet inserted into the sheet inserting unit are printed; and a sheet directing unit configured to direct, as a reuse sheet, a one-side-unused sheet detected by the printing detecting unit as not being printed on one of a front side and a rear side to the reuse sheet storing space corresponding to the user ID recognized by the ID recognizing unit and store the sheet in the reuse sheet storing space.

### CROSS-REFERENCE TO RELATED APPLICATION

The present invention is based upon and claims the benefit of priority from the provisional application No. 61/248,608 filed Oct. 5, 2009, the entire content of which incorporated herein by reference.

### FIELD

Embodiments described herein relate generally to a sheet sorting and storing apparatus and a sheet sorting and storing method that employ individual authentication.

### BACKGROUND

When it is desired to send a certain document to a specific individual, an individual authentication system is often used in, for example, a facsimile apparatus, an image forming apparatus having multiple functions such as a communication function, or the like installed in general.

This system performs printing or the like using a card, which stores a user ID for identifying an individual, when a user intends to perform the printing.

In recent years, from the viewpoint of effectively utilizing resources, it is becoming important in a copying machine or the like to use, even if one side of a sheet is printed, the unused other side. A document sorting system for this purpose is being developed.

To reuse the sheet printed on one side in this way, it is convenient in the reuse to accumulate the sheet in a cassette or the like with the unused side arranged on an upper side or a lower side, i.e., one side. There is known a paper feeding system for an image forming apparatus configured to store a sheet with a side on which an image is not formed (a white side) arranged, for example, on the upper side.

However, not all sheets once used are printed only on one side. In some case, even if only one side of a sheet is printed, an important matter is described on the side. Even if a matter described on a printed side is not an important matter, some people do not like to print the other side of a sheet, on one side of which the matter described by another person is printed.

According to an embodiment, there is provided a sheet sorting and storing apparatus and a sheet sorting and storing method for sorting various documents including a confidential document and a printed sheet without wasting sheets and while keeping security. In the sheet sorting and storing apparatus and the sheet sorting and storing method, a user uses only sheets printed by the user himself or herself when the user reuses sheets.

With the sheet sorting and storing apparatus and the sheet sorting and storing method according to the embodiment, it is possible to flexibly set a confidentiality level for treating a document as a confidential document.

### BRIEF DESCRIPTION OF THE DRAWINGS

FIG. 1 is a diagram of the configuration of a sheet sorting and storing apparatus according to a first embodiment;

FIG. 2 is a diagram of a configuration example of a sheet reversing mechanism in the first embodiment;

FIG. 3 is a diagram of a configuration example of a printing detector in the first embodiment;

FIG. 4 is a diagram of a configuration example of a confidentiality-indication-level determining unit in the first embodiment;

FIG. 5 is a diagram of a configuration example of an electric control block in the first embodiment;

FIG. 6 is a diagram of a configuration example of an ID recognizing unit in the first embodiment;

FIG. 7 is a flowchart for explaining the operation of the first embodiment;

FIG. 8 is a diagram of the configuration of a sheet sorting and storing apparatus according to a second embodiment; and

FIG. 9 is a diagram of the configuration of a sheet sorting and storing apparatus according to a third embodiment.

### DETAILED DESCRIPTION

In general, according to one embodiment, a sheet sorting and storing apparatus includes: an ID recognizing unit configured to recognize a user ID for identifying a user; a sheet storing unit including plural reuse sheet storing spaces each provided to correspond to the user ID recognized by the ID recognizing unit; a sheet inserting unit into which a sheet is inserted; a printing detecting unit configured to detect whether a front side and a rear side of the sheet inserted into the sheet inserting unit are printed; and a sheet directing unit configured to direct, as a reuse sheet, a one-side-unused sheet detected by the printing detecting unit as not being printed on one of a front side and a rear side to the reuse sheet storing space corresponding to the user ID recognized by the ID recognizing unit and store the sheet in the reuse sheet storing space.

Embodiments of the sheet sorting and storing apparatus are explained below with reference to the accompanying drawings.

### First Embodiment

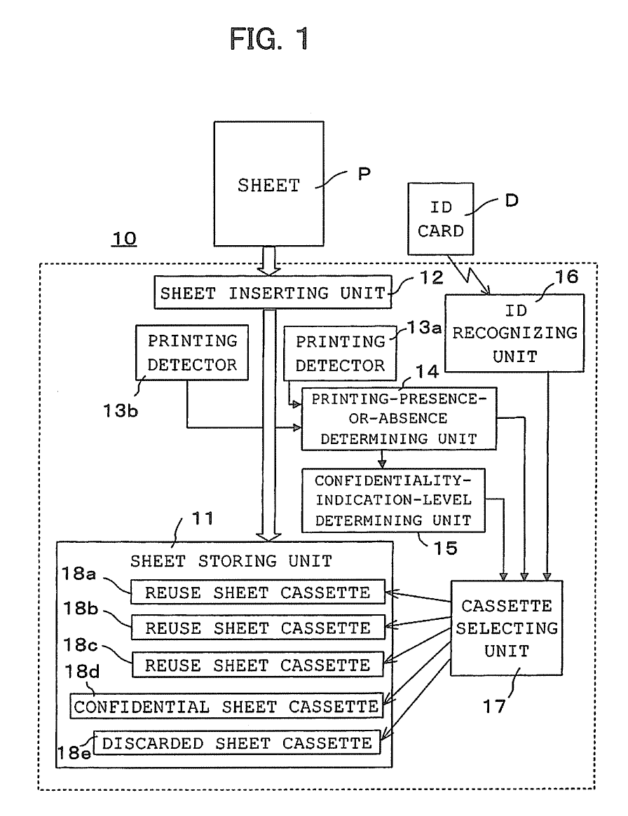

An overall configuration of a sheet sorting and storing apparatus according to a first embodiment is shown in FIG. 1. A sheet sorting and storing apparatus 10 includes a sheet storing unit 11 in which reuse sheets, unused sheets, confidential sheets, and discarded sheets are stored, a sheet inserting unit 12 into which a sheet P is inserted from the outside, printing detectors 13a and 13b configured to respectively detect presence or absence of printing on a front side and a rear side of the sheet P inserted from the sheet inserting unit 12, a printing-presence-or-absence determining unit 14 configured to determine presence or absence of printing on the front side and the rear side of the sheet according to outputs from the printing detectors 13a and 13b, a confidentiality-indication-level determining unit 15 configured to determine, when a confidentiality indication level is described, whether the level exceeds a predetermined set level, an ID recognizing unit 16 configured to recognize a user ID stored in an ID card D owned by a user, and a cassette selecting unit 17 configured to direct the inserted sheet to each of cassettes of the sheet storing unit 11 and store the sheet therein on the basis of the user ID recognized by the ID recognizing unit 16, a printing state of the sheet recognized by the printing-presence-or-absence determining unit 14, and the confidentiality level determined by the confidentiality-indication-level determining unit 15.

The sheet storing unit 11 includes three reuse sheet cassettes 18a, 18b, and 18c in which one-side-unused sheets printed on one of front sides and rear sides and not printed on the other sides are stored, a confidential sheet cassette 18d in which confidential sheets, on which contents of confidentiality levels equal to or higher than a predetermined confidentiality level are printed, are stored, and a discarded sheet cassette 18e in which sheets to be discarded because both sides of which are printed are stored. These cassettes are provided a predetermined space apart from one another in the vertical direction such that the sheets can be stored.

The reuse sheet cassettes 18a, 18b, and 18c correspond to Da, Db, and Dc, which are user IDs of three users A, B, and C. The users and the reuse sheet cassettes are set to correspond to each other in advance. When the user A causes the ID recognizing unit 16 to recognize the ID card D, if a sheet inserted into the sheet inserting unit 12 is a one-side-unused sheet, the sheet is stored in the reuse sheet cassette 18a. When the user B causes the ID recognizing unit 16 to recognize the ID card D, if a sheet inserted into the sheet inserting unit 12 is a one-side-unused sheet, the sheet is stored in the reuse sheet cassette 18b.

When the user C causes the ID recognizing unit 16 to recognize the ID card D, if a sheet inserted into the sheet inserting unit 12 is a one-side-unused sheet, the sheet is stored in the reuse sheet cassette 18c. In this way, the cassette in which the one-side-unused sheet is stored is different depending on the user.

When these one-side-unused sheets are stored in the reuse sheet cassettes, the one-side-unused sheets are stored with, for example, unused sides facing up.

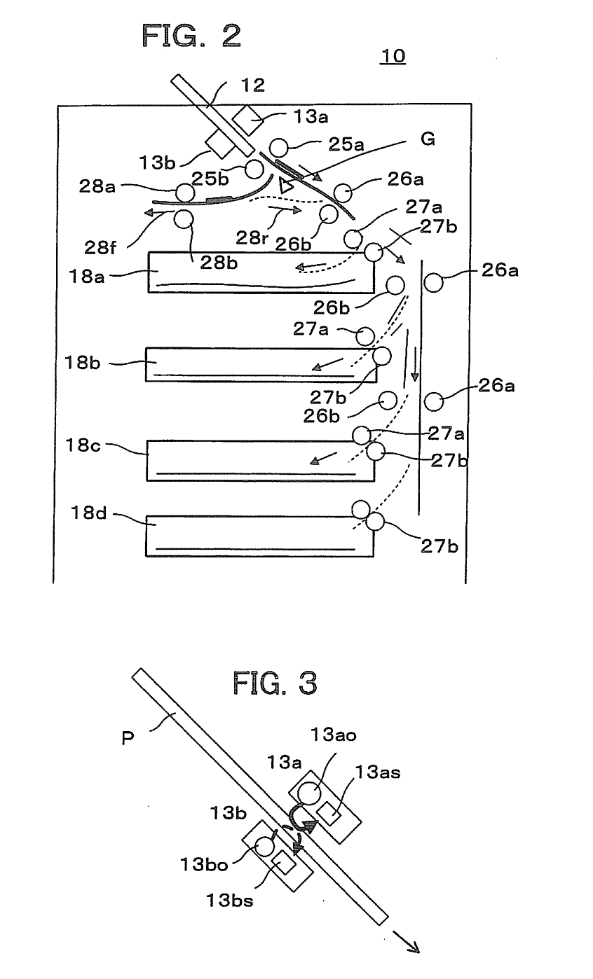

A part of a mechanism for, for example, facing the unused sides up in this way is shown in FIG. 2. In FIG. 2, the unused sheet cassettes 18a, 18b, and 18c in three stages and the confidential sheet cassette 18d in a stage under the unused sheet cassettes 18a, 18b, and 18c are shown. However, the discarded sheet cassette 18e under the confidential sheet cassette 18d is not shown.

This mechanism for directing sheets configures a sheet selecting unit and is a specific mechanism of the cassette selecting unit 17 shown in FIG. 1. The mechanism includes a reversing mechanism for feeding the one-side-unused sheets to the reuse sheet cassettes 18a, 18b, and 18c. The reversing mechanism reverses, when an unused side of a sheet faces downward, the sheet to face the unused side up.

This mechanism includes the printing detectors 13a and 13b configured to detect presence or absence of printing on both sides of a sheet inserted from the sheet inserting unit 12, a pair of conveying rollers 25a and 25b configured to convey the sheet to the inside, plural pairs of conveying rollers 26a and 26b configured to convey the sheet through a common path, storing rollers 27a and 27b configured to store the sheet in the cassettes from the common path, and a pair of reversing rollers 28a and 28b for reversing, when it is necessary to reverse the sheet, the sheet that exits the conveying rollers 25a and 25b. When the sheet is reversed, the sheet is once conveyed in an arrow 28f direction by normal rotation of the reversing rollers 28a and 28b. Thereafter, the sheet is led in an arrow 28r direction by reversely rotating the reversing rollers 28a and 28b. The sheet is caused to pass between the pair of rollers 26a and 26b.

Sheets inserted into the sheet inserting unit 12 of the sheet sorting and storing apparatus 10 are classified into sheets having indication of a confidential document and sheets not having the indication of a confidential document. The sheets not having the indication of a confidential document include sheets printed only on one sides and sheets printed on both side. A sheet not having the confidentiality indication and printed on both sides is treated as being discarded and is stored in the discarded sheet cassette 18e. A sheet not having the confidentiality indication and printed only on one side is stored in the reuse sheet cassette 18a, 18b, or 18c with an unused side arranged for reuse. The reuse sheet cassette in which the sheet is stored are determined according to a user ID recognized by the ID recognizing unit 16.

Any one of confidentiality levels 1 to 5 is indicated on the sheet having the indication of a confidential document. An indicated confidentiality level DL is compared with a set level SL set in advance and determined by the confidentiality-indication-level determining unit 15. If the confidentiality (indication) level DL is higher than the set level SL, the sheet is stored in the confidential sheet cassette 18d.

On the sheet printed on both sides, in some case, confidentiality levels are indicated on both the sides. If the confidentiality levels indicated on both the sides are different, a higher confidentiality indication level is compared with the set level.

In some case, a confidentiality indication level is indicated on one side but a confidentiality indication level is not indicated on the other side. In this case, the indicated confidentiality indication level and the set level are compared. If it is determined that the indicated confidentiality indication level is higher than the set level, this sheet is treated as a confidential sheet and stored in the confidential sheet cassette 18d.

The sheet printed on both sides having the confidentiality indication level DL equal to or lower than the set level SL is stored in the discarded sheet cassette 18e.

If the confidentiality indication level DL indicated on a sheet is equal to or lower than the set level SL and one side of the sheet is unused, the sheet is stored in the reuse sheet cassette 18a, 18b, or 18c according to a user ID.

In the confidential sheet printed only on one side, the side already printed (a used side) faces up or faces down. In this embodiment, when one-side-unused sheets are stored in the confidential sheet cassette, used sides of the sheets are not arranged.

The printing detectors 13a and 13b include, for example, as shown in FIG. 3, light sources 13ao and 13bo provided on an opposed surface and a rear surface of the sheet inserting unit 12 and configured to irradiate light to the sheet P and optical sensors 13as and 13bs of, for example, a line shape configured to detect reflected light from the sheet P of the light irradiated from the light sources.

The printing-presence-or-absence determining unit 14 is a circuit configured to determine a printed line or the like and also determine whether printing is detected by one of the printing detectors 13a and 13b.

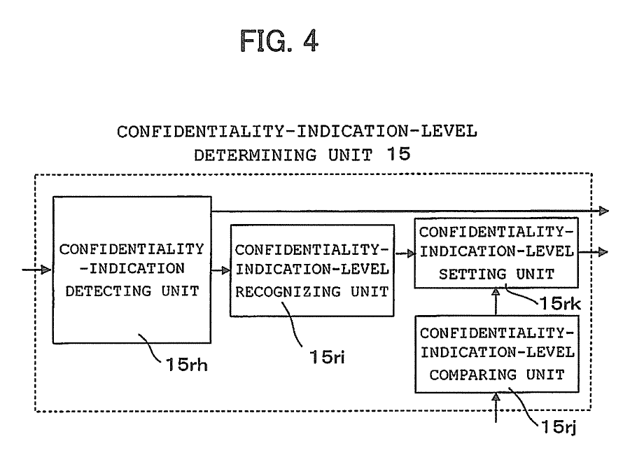

The confidentiality-indication-level determining unit 15 includes, for example, as shown in FIG. 4, a confidentiality-indication detecting unit 15rh, a confidentiality-indication-level recognizing unit 15ri, a confidentiality-indication-level setting unit 15rj, and a confidentiality-indication-level comparing unit 15rk.

When confidentiality indication is detected by the confidentiality-indication detecting unit 15rh, the confidentiality-indication-level recognizing unit 15ri recognizes a confidentiality indication level of the confidentiality indication and sends the recognized confidentiality indication level to the confidentiality-indication-level comparing unit 15rk.

On the other hand, a set level of confidentiality set in advance by the confidentiality-indication-level setting unit 15rj is input to the confidentiality-indication-level comparing unit 15rk. This set level maybe set to, for example, 3 as an initial value and changed by a ten key provided on an upper surface panel of an apparatus main body of the sheet sorting and storing apparatus 10. The set level SL of confidentiality may be changed every time a button is pressed. If a set level of a confidential sheet can be changed or input from the upper surface of the apparatus main body in this way, there is an advantage that a range of documents treated as confidential documents can be easily and flexibly changed according to content printed on a sheet.

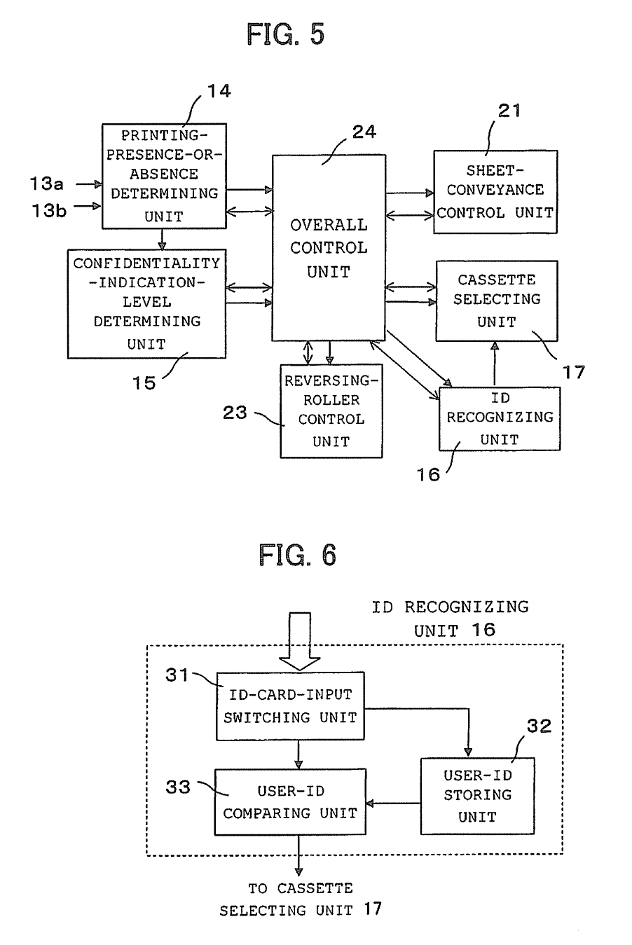

The confidentiality-indication-level comparing unit 15rk compares the confidentiality indication level DL input from the confidentiality-indication-level recognizing unit 15ri with the set level SL input from the confidentiality-indication-level setting unit 15rj. The confidentiality-indication-level comparing unit 15rk sends a comparison result signal indicating whether the confidentiality indication level DL is larger than the set level SL to an overall control unit 24 (see FIG. 5) explained later.

The printing-presence-or-absence determining unit 14 sends a printing presence or absence signal indicating whether front and rear sides are printed to the overall control unit 24. When confidentiality indication is not detected, the confidentiality-indication detecting unit 13rh sends a control signal to that effect to the overall control unit 24.

The light source 13ao of the printing detector 13a irradiates, in a predetermined range, light on the sheet P reversely inserted into the printing detector 13a. The optical sensor 13as receives reflected light of the light. When some description such as a character is detected in this range, the printing detector 13a recognizes that a side of this range of the sheet P is printed. In this range, for example, a confidentiality level is indicated. The printing detector 13b also has a range of the same position on the rear side of the sheet P.

The printing-presence-or-absence determining unit 14 obtains an electric signal from the reflected light obtained from the optical sensors of the printing detectors 13a and 13b and recognizes whether the sides of the sheet P are printed.

The confidentiality-indication-level determining unit 15 also incorporates a comparing circuit configured to recognize indication of a confidentiality level of a confidential sheet, for example, a two-dimensional barcode on a side determined as being printed and compares the confidentiality indication level with a confidentiality level set in advance. There are five confidentiality levels 1 to 5. 1 indicates highest confidentiality and 5 indicates lowest confidentiality. In a sheet not having indication of a confidential sheet, confidentiality is much lower. The indication of a confidential sheet can be omitted if the confidentiality level is indicated. The two-dimensional barcode is usually displayed in a barcode format.

A configuration example of an electric control block in the sheet sorting and storing apparatus 10 according to this embodiment is shown in FIG. 5. The sheet sorting and storing apparatus 10 includes the printing-presence-or-absence determining unit 14 configured to determine presence or absence of printing on the surface of the sheet P, the confidentiality-indication-level determining unit 15 configured to determine, when there is a printed side and a confidentiality indication level is described, the confidentiality indication level, the ID recognizing unit 16 configured to recognize a user ID stored in the ID card D, the cassette selecting unit 17 configured to select a cassette in which sheets are stored, a sheet-conveyance control unit 21 configured to control rotation of the conveying rollers to thereby control conveyance of the sheet P and storage of the sheet P in the cassettes, a reversing-roller control unit 23 configured to control rotation and a rotating direction of the reversing rollers 28a and 28b, and the overall control unit 24 configured to control these units.

The overall control unit 24 receives information indicating whether the front side and the rear side of the sheet P are printed from the printing-presence-or-absence determining unit 14. The overall control unit 24 also receives information indicating whether a confidentiality indication level is indicated from the confidentiality-indication-level determining unit 15. According to a result of the reception of the information, the overall control unit 24 drives the sheet-conveyance control unit 21 and controls rotation of the conveying rollers 25a, 25b, 26a, and 26b, the storing rollers 27a and 27b, and the reversing rollers 28a and 28b. Control explained below is performed according to the control by the overall control unit 24.

The sheet P inserted from the sheet inserting unit 12 is conveyed along a conveying path formed by the several pairs of conveying rollers 25a, 25b, 26a, and 26b. The sheet P is stored in the reuse sheet cassette 18a, 18b, or 18c, a confidential sheet cassette 18d, or the discarded sheet cassette 18e by the pair of storing rollers 27a and 27b according to types of sheets stored in the cassettes. The sheet cassette in which the sheet P is stored is determined according to a situation in which printing is detected by the printing detectors 13a and 13b.

Further, the pair of reversing rollers 28a and 28b are provided near the conveying rollers 25a and 25b in a position close to the sheet inserting unit 12 and a sheet reversing conveying path is formed. For example, it is assumed that a sheet printed only on a rear side is inserted into the sheet inserting unit 12. At this point, the printing of the sheet is not detected by the printing detector 13a configured to detect printing on the front side of the sheet P. The printing is detected by the printing detector 13b configured to detect printing on the rear side of the sheet P.

The sheet inserted from the sheet inserting unit 12 and passing the first conveying rollers 25a and 25b is once conveyed in an upper left direction in the figure according to a normal direction rotation of the pair of reversing rollers 28a and 28b by control of a gate G. Thereafter, the sheet P is switched back according to reverse rotation of the rollers 28a and 28b, conveyed again, and stored in the reuse sheet cassette 14a by the storing rollers 27a and 27b. The sheet P is stored in the reuse sheet cassette 18a with the printed side facing down.

If the sheet P has indication of a confidentiality level and it is recognized that the confidentiality level is higher than a predetermined confidentiality level, for example, the level 3, the sheet P is stored in the confidential sheet cassette 18c.

If printing is detected on both the sides by the printing detectors 13a and 13b and indication of a confidentiality level is not detected, the sheet P is stored in the discarded sheet cassette 18e. If printing is detected on one side by the printing detector 13a or the printing detector 13b and indication of a confidentiality level is not detected, the sheet P is stored in the reuse sheet cassette 18a with the printed side facing down.

A configuration example of the ID recognizing unit 16 is shown in FIG. 6. The ID recognizing unit 16 includes an ID-card-input switching unit 31, a user-ID storing unit 32 configured to store a user ID and the like input to the ID-card-input switching unit 31 in a registration mode, and a user-ID comparing unit 33 configured to compare, in a comparison mode, a user ID input via the ID-card-input switching unit 31 with the user ID stored in the user-ID storing unit 32 and, if the user IDs coincide with each other, send the input user ID to the cassette selecting unit 17. The cassette selecting unit 17 detects the user ID sent from the user-ID comparing unit 33. If a sheet inserted into the sheet inserting unit 12 is a reuse sheet, the reuse sheet is stored in a reuse sheet cassette corresponding to the user ID.

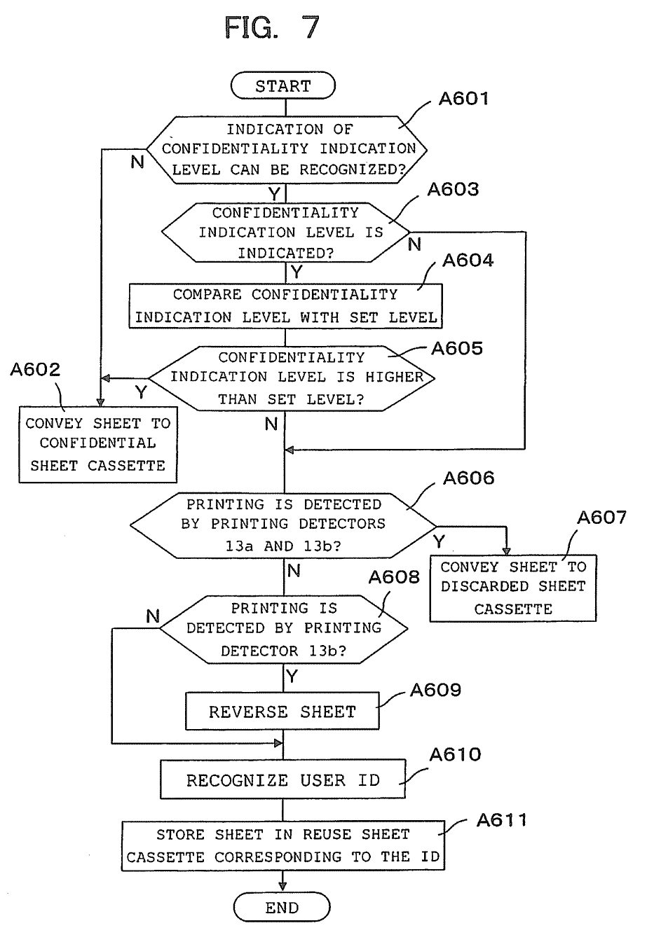

The operation of the sheet sorting and storing apparatus 10 according to this embodiment is explained below with reference to a flowchart shown in FIG. 7.

In Act A601, first, the sheet sorting and storing apparatus 10 checks whether indication of a confidentiality indication level can be recognized. In the printing detectors 13a and 13b, light is irradiated to the sheet P from the light sources 13ao and 13bo on the inside and reflected light of the light is received by the optical sensors 13as and 13bs. The sheet sorting and storing apparatus 10 converts the received light into an electric signal and detects, according to whether the electric signal fluctuates, whether the sheet P is printed. The sheet sorting and storing apparatus 10 recognizes presence or absence of indication of a confidentiality level and, if the indication is present, recognizes a confidentiality indication level.

If this confidentiality indication is not recognized, in the worst case, the confidentiality level is likely to be 1 or 2. Therefore, in FIG. 7, if the indication of a confidentiality indication level is not recognized (N in A601), in Act A602, the sheet sorting and storing apparatus 10 conveys the sheet P to the confidential sheet cassette 18d and stores the sheet P in this cassette.

In the next Act A603, the sheet sorting and storing apparatus 10 determines whether the indication of a confidentiality indication level is present. If the confidentiality indication level is indicated (Y in A603) the sheet sorting and storing apparatus 10 shifts to Act A604 and compares the confidentiality indication level DL with the set level SL in Act A604.

If the confidentiality indication level is higher than the set level in the next Act A605 (Y in A605), the sheet sorting and storing apparatus 10 shifts to Act A602. The sheet sorting and storing apparatus 10 conveys the sheet P to the confidential sheet cassette 18d and stores the sheet P in this cassette.

On the other hand, if the confidentiality indication level is the same as or lower than the set level in Act A605 (N in A605), the sheet sorting and storing apparatus 10 shifts to Act A606. In Act A606, the sheet sorting and storing apparatus 10 detects, with the printing detectors 13a and 13b, whether printing is detected and determines, in the printing-presence-or-absence determining unit 14, whether both sides of the sheet P are printed. In this case, the sheet P is the confidential document but the confidentiality level thereof is low and both the sides are printed. The sheet sorting and storing apparatus 10 sends the sheet P to the discarded sheet cassette 18e.

When it is recognized in Act A603 that the indication of a confidentiality indication level is not present (N in A603), the sheet sorting and storing unit 10 shifts to Act A606 in the same manner and checks whether printing is detected by the printing detectors 13a and 13b, i.e., whether both the sides of the sheet P are printed. If both the sides of the sheet P are printed (Y in A606), the sheet sorting and storing apparatus 10 shifts to Act A607. The sheet sorting and storing apparatus 10 conveys the sheet P to the discarded sheet cassette 18e and stores the sheet P in this cassette.

On the other hand, if printing is not detected by the printing detector 13a and the printing detector 13b in Act A606 (N in A606), in Act A608, the sheet sorting and storing apparatus 10 checks whether printing is detected by the printing detector 13b.

If the printing is detected by the printing detector 13b (Y in S608), this means that only the rear side of the sheet P is printed. Therefore, in the next Act A609, the sheet sorting and storing apparatus 10 reverses the sheet P. Specifically, the overall control unit 24 sends a control signal to the gate control unit 22 and operates the gate G shown in FIG. 1 such that the sheet P is conveyed to the reversing rollers 28a and 28b. The sheet P printed on the rear side is conveyed in a left direction (an arrow 28f) on FIG. 2 according to normal rotation of the reversing rollers 28a and 28b.

After the trailing end of the sheet P is released from the conveying rollers 25a and 25b, the sheet sorting and storing apparatus 10 reversely rotates the reversing rollers 28a and 28b and conveys the sheet P in an arrow 28r direction via the conveying rollers 26a and 26b.

In the next Act A610, the sheet sorting and storing apparatus 10 refers to the user ID recognized by the ID recognizing unit 16. The sheet sorting and storing apparatus 10 stores, with the storing rollers 27a and 27b, the sheet P in any one of the reuse sheet cassettes 18a, 18b, and 18c corresponding to the user ID with the printed side facing down (Act A611).

If printing is not detected by the printing detector 13b in Act A608 (N in A608), printing is detected by the printing detector 13a. In this case, the front side of the sheet P is printed. In this case, the sheet sorting and storing apparatus 10 conveys, with the conveying rollers 26a and 26b, the sheet P from the conveying rollers 25a and 25b and stores, with the storing rollers 27a and 27b, the sheet P in any one of the reuse sheet cassettes 18a, 18b, and 18c. In this case, as in the case explained above, the printed side of the sheet P is the lower side and the upper side is an unused side.

In this way, according to this embodiment, a confidential sheet having a confidentiality level exceeding the set level is stored in the confidential sheet cassette 18d. On the other hand, a sheet printed on both sides and not having confidentiality indication and a sheet printed on both the sides and having a low confidentiality level is stored in the discarded sheet cassette 18e.

A sheet printed on one side and not having confidentiality indication and a sheet printed on one side and having a low confidentiality level are stored in any one of the reuse sheet cassettes 18a, 18b, and 18c corresponding to the user ID with the printed side facing down. In the flowchart shown in FIG. 7, the recognition of the user ID is performed in a relatively later stage. However, it is difficult to stop a reuse sheet during conveyance. Therefore, when the apparatus is actually used, it is desirable to cause the ID recognizing unit 16 to recognize an ID card before the sheet is inserted.

According to this embodiment, an unused sheet printed on one side by a user can be stored in an unused sheet cassette corresponding to a user ID stored in an ID card. Therefore, the user can reuse a sheet printed on one side by the user.

According to this embodiment, it is possible to reverse a sheet according to normal rotation and reverse rotation of the reversing rollers and store sheets with unused sides thereof arranged as one side.

In this embodiment, there is an advantage that even a sheet having confidentiality indication can be reused if a confidentiality level is equal to or lower than the predetermined level, i.e., a confidentiality degree is low. Moreover, since a set level of the confidentiality can be set from the outside, there is also an advantage that it is possible to flexibly change, according to a situation, a confidential document that is not reused and is treated as confidential.

It goes without saying that it is also possible to treat all sheets having indication of confidentiality indication levels as confidential sheets.

### Second Embodiment

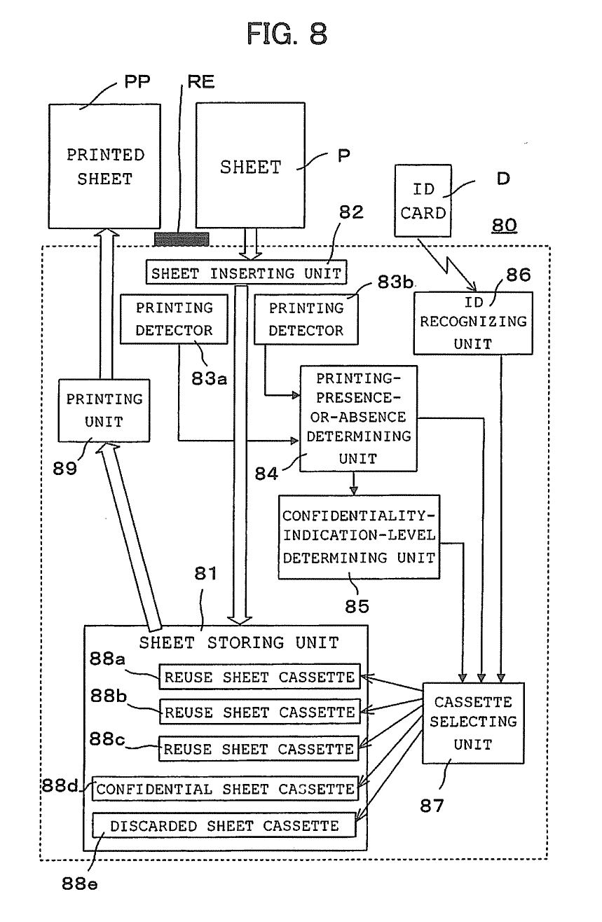

In the first embodiment, the apparatus that sorts sheets, only one sides of which are used, for each of users and stores the sheets is explained. However, it is also possible to add a function of performing printing using, for each of the users, reuse sheets of each of the users sorted in this way. Such a second embodiment is explained below. The configuration of a sheet sorting and storing apparatus according to this embodiment is shown in FIG. 8. In FIG. 8, reference numerals and signs 80 to 88e correspond to reference numerals and signs 10 to 18e shown in FIG. 1. A sheet sorting and storing apparatus 80 includes a printing unit 89 besides the units denoted by reference numerals and signs 10 to 18e. Sheets stored in the reuse sheet cassettes 88a, 88b, and 88c and printed by the printing unit 89 are discharged to the outside.

Specifically, the sheet sorting and storing apparatus 80 includes a sheet storing unit 81 in which reuse sheets, unused sheets, confidential sheets, and discarded sheets are stored, a sheet inserting unit 82 into which a sheet P is inserted from the outside, printing detectors 83a and 83b configured to respectively detect presence or absence of printing on a front side and a rear side of the sheet P inserted from the sheet inserting unit 82, a printing-presence-or-absence determining unit 84 configured to determine presence or absence of printing on the front side and the rear side of the sheet according to outputs from the printing detectors 83a and 83b, a confidentiality-indication-level determining unit 85 configured to determine, when a confidentiality indication level is described, whether the level exceeds a predetermined set level, an ID recognizing unit 86 configured to recognize a user ID stored in an ID card D owned by a user, and a cassette selecting unit 87 configured to direct the inserted sheet to each of cassettes of the sheet storing unit 81 and store the sheet therein on the basis of the user ID recognized by the ID recognizing unit 86, a printing state of the sheet recognized by the printing-presence-or-absence determining unit 84, and the confidentiality level determined by the confidentiality-indication-level determining unit 85.

The sheet storing unit 81 includes three reuse sheet cassettes 88a, 88b, and 88c in which one-side-unused sheets printed on one of front sides and rear sides and not printed on the other sides are stored, a confidential sheet cassette 88d in which confidential sheets, on which contents of confidentiality levels equal to or higher than a predetermined confidentiality level are printed, are stored, and a discarded sheet cassette 88e in which sheets to be discarded because both sides of which are printed are stored. These cassettes are provided a predetermined space apart from one another in the vertical direction such that the sheets can be stored.

In this embodiment, the mechanism shown in FIG. 2 can be used as a sheet reversing mechanism. For example, the printing detectors shown in FIG. 3 can be used as the printing detectors 83a and 83b. For example, the circuit shown in FIG. 4 can be used as the confidentiality-indication-level determining unit 85. For example, the configuration shown in FIG. 5 can be used as an electric control block in the sheet sorting and storing apparatus 80 according to this embodiment. Further, for example, the configuration shown in FIG. 6 can be used as the ID recognizing unit 86.

First, a sheet storing mode in this embodiment is explained.

A user brings the ID card D close to the ID recognizing unit 16 to cause the ID recognizing unit 16 to recognize a user ID. In this embodiment, as in the first embodiment, the printing detectors 83a and 83b detect whether front and rear sides of a sheet inserted from the sheet inserting unit 82 are printed. The printing-presence-or-absence determining unit 84 determines presence or absence of printing on the front and rear sides. The confidentiality-indication-level determining unit 85 recognizes whether a confidentiality indication level is described on the sheet and, if described, which level the confidentiality indication level is. The confidentiality-indication-level determining unit 85 determines, according to the level, whether the sheet is treated as a confidential sheet.

Thereafter, the sheet sorting and storing apparatus 80 stores, according to the determination of the presence or absence of printing on the front and rear sides and the confidentiality indication level of the sheet inserted into the sheet inserting unit 82, the sheet in the confidential sheet cassette 88d or the discarded sheet cassette 88e.

The sheet sorting and storing apparatus 80 stores a sheet, one side of which is not used, not having indication of a confidentiality indication level or a sheet having a confidentiality indication level, which is equal to or lower than a set level, in anyone of the reuse sheet cassettes 88a, 88b, and 88c with, for example, an unused side facing up. At this point, the sheet sorting and storing apparatus 80 refers to the user ID temporarily stored in the ID recognizing unit 86.

A reuse mode in the sheet sorting and storing apparatus 80 is explained below. In the reuse mode, the user presses a button RE provided on, for example, an upper side of the sheet sorting and storing apparatus 80. At this point, as in the sheet storing mode, first, the user brings the ID card D close to the ID recognizing unit 86 of the apparatus and causes the ID recognizing unit 86 to recognize the user ID. Information concerning the user ID is sent from the ID recognizing unit 86 to the cassette selecting unit 87. According to the information, the cassette selecting unit 87 conveys a reuse sheet, an upper side of which is unused, from a reuse cassette corresponding to the user ID, for example, the reuse cassette 88a. The sheet sorting and storing apparatus 80 prints the sheet in the printing unit 89 and discharges a printed sheet PP.

According to this embodiment, there is an advantage that the user can print a rear side of a reuse sheet printed on one side by the user and stored in a reuse sheet cassette. Therefore, the user does not print a rear side of a sheet printed on one side by another person. In this embodiment, the user can print the reuse sheet without extracting the reuse sheet from the apparatus and, in the reuse mode, simply by pressing the button RE.

### Third Embodiment

A sheet sorting and storing apparatus according to a third embodiment can also be connected to an image forming apparatus as a sheet supplying apparatus. Such a third embodiment is explained below. In the third embodiment, the sheet sorting and storing apparatus is provided as an option of the image forming apparatus.

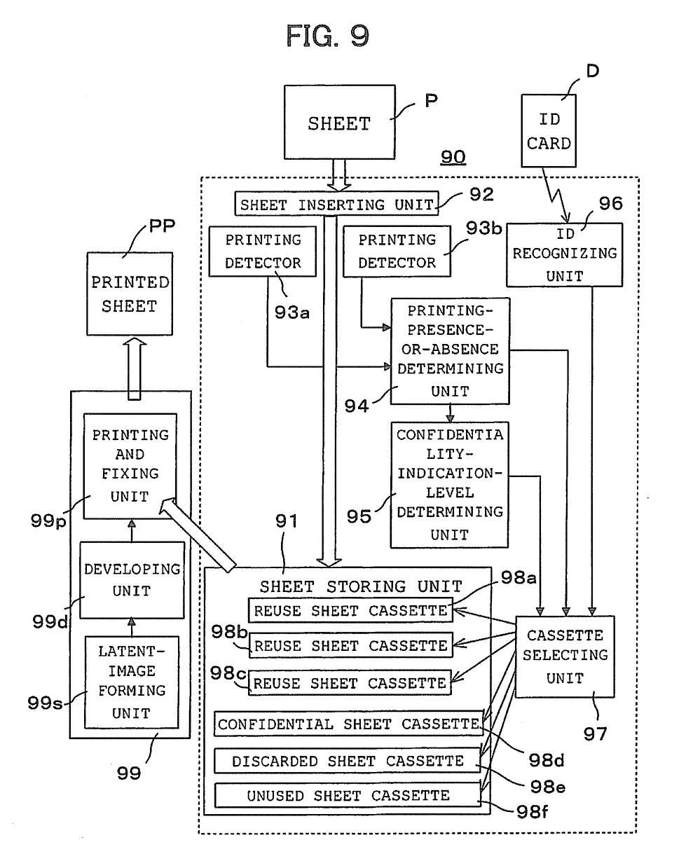

An overall configuration of the sheet sorting and storing apparatus according to this embodiment is shown in FIG. 9. In FIG. 9, reference numerals and signs 90 to 98e correspond to reference numerals and signs 10 to 18e shown in FIG. 1. A sheet sorting and storing apparatus 90 is connected to an image forming apparatus 99.

The image forming apparatus 99 includes a latent-image forming unit 99s configured to form a latent image with selective exposure to light, a developing unit 99d configured to develop the latent image with, for example, toner powder, and a printing and fixing unit 99p configured to fix a developed toner image on a sheet to thereby print the toner image. The sheet PP printed by the printing and fixing unit 99p is discharged to the outside.

The sheet sorting and storing apparatus 90 includes a sheet storing unit 91 in which reuse sheets, unused sheets, confidential sheets, and discarded sheets are stored, a sheet inserting unit 92 into which a sheet P is inserted from the outside, printing detectors 93a and 93b configured to respectively detect presence or absence of printing on a front side and a rear side of the sheet P inserted from the sheet inserting unit 92, a printing-presence-or-absence determining unit 94 configured to determine presence or absence of printing on the front side and the rear side of the sheet according to outputs from the printing detectors 93a and 93b, a confidentiality-indication-level determining unit 95 configured to determine, when a confidentiality indication level is described, whether the level exceeds a predetermined set level, an ID recognizing unit 96 configured to recognize a user ID stored in an ID card D owned by a user, and a cassette selecting unit 97 configured to direct the inserted sheet to each of cassettes of the sheet storing unit 91 and store the sheet therein on the basis of the user ID recognized by the ID recognizing unit 96, a printing state of the sheet recognized by the printing-presence-or-absence determining unit 94, and the confidentiality level determined by the confidentiality-indication-level determining unit 95.

The sheet storing unit 91 includes three reuse sheet cassettes 98a, 98b, and 98c in which one-side-unused sheets printed on one of front sides and rear sides and not printed on the other sides are stored, a confidential sheet cassette 98d in which confidential sheets, on which contents of confidentiality levels equal to or higher than a predetermined confidentiality level are printed, are stored, a discarded sheet cassette 98e in which sheets to be discarded because both sides of which are printed are stored, and an unused sheet cassette 98f in which unused sheets not printed on both sides are stored. These cassettes are provided a predetermined space apart from one another in the vertical direction such that the sheets can be stored.

First, storage of an unused sheet for the like in a cassette in this embodiment is explained.

A user brings the ID card D close to the ID recognizing unit 96 to cause the ID recognizing unit 96 to recognize a user ID. In this embodiment, as in the first embodiment, the printing detectors 93a and 93b detect whether front and rear sides of a sheet inserted from the sheet inserting unit 92 are printed. The printing-presence-or-absence determining unit 94 determines presence or absence of printing on the front and rear sides. The confidentiality-indication-level determining unit 95 recognizes whether a confidentiality indication level is described on the sheet and, if described, which level the confidentiality indication level is. The confidentiality-indication-level determining unit 95 determines, according to the level, whether the sheet is treated as a confidential sheet.

Thereafter, the sheet sorting and storing apparatus 90 stores, according to the determination of the presence or absence of printing on the front and rear sides and the confidentiality indication level, the sheet inserted into the sheet inserting unit 92 in the confidential sheet cassette 98d or the discarded sheet cassette 98e.

The sheet sorting and storing apparatus 90 stores a sheet, one side of which is not used, not having indication of a confidentiality indication level or a sheet having a confidentiality indication level, which is equal to or lower than a set level, in any one of the reuse sheet cassettes 98a, 98b, and 98c with, for example, an unused side facing up. At this point, the sheet sorting and storing apparatus 90 refers to the user ID temporarily stored in the ID recognizing unit 96.

Supply of a reuse sheet or the like to the image forming apparatus 99, to which the sheet sorting and storing apparatus 90 is connected, is explained below.

In this case, as in the above explanation, the user brings the ID card D close to the ID recognizing unit 96 of the apparatus and causes the ID recognizing unit 96 to recognize the user ID. Information concerning the user ID is sent from the ID recognizing unit 96 to the cassette selecting unit 97. According to the information, the cassette selecting unit 97 conveys a reuse sheet, an upper side of which is unused, from a reuse cassette corresponding to the user ID, for example, the reuse cassette 98a. The sheet sorting and storing apparatus 90 conveys the reuse sheet to the printing and fixing unit 99p of the image forming apparatus 99.

Before the reuse sheet is conveyed, the latent-image forming unit 99s of the image forming apparatus 99 forms a latent image. The developing unit 99d develops the latent image with, for example, toner powder and sends a developed image to the printing and fixing unit 99p. The printing and fixing unit 99p prints the reuse sheet conveyed from the sheet storing unit 91. The reuse sheet of the user who brings the ID card D close to the ID recognizing unit 96 earlier is used. The image forming unit 99 discharges the printed sheet PP.

According to this embodiment, in the image forming apparatus 99, there is an advantage that the user can print a developed image on a rear side of a reuse sheet printed on one side by the user and stored in a reuse sheet cassette. Therefore, the user does not print a rear side of a sheet printed on one side by another person.

In this embodiment, the unused sheet cassette 98f is provided. Therefore, when the user desires to perform duplex printing of images in the image forming apparatus 99, it is possible to convey a sheet not printed on both sides from the unused sheet cassette 98f of the sheet storing unit 91 to the sheet fixing unit 99p and perform the duplex printing.

It goes without saying that it is also possible to provide a normal sheet supplying unit configured to store sheets, both sides of which are not used, and usually supply a sheet from this sheet supplying unit and, only when a reuse sheet is used, convey the reuse sheet from the sheet storing unit 91 of the sheet sorting and storing apparatus 90.

In this embodiment, the mechanism shown in FIG. 2 can be used as a sheet reversing mechanism. For example, the printing detectors shown in FIG. 3 can be used as the printing detectors 93a and 93b. For example, the circuit shown in FIG. 4 can be used as the confidentiality-indication-level determining unit 95. For example, the configuration shown in FIG. 5 can be used as an electric control block in the sheet sorting and storing apparatus 90 according to this embodiment. Further, for example, the configuration shown in FIG. 6 can be used as the ID recognizing unit 96.

In this embodiment, as in the first and second embodiments, even a sheet having a confidentiality level lower than the set level and having an unused side can be reused. Moreover, since the set level of the confidentiality can be set from the outside, it is also possible to easily and flexibly prevent a confidential sheet having a predetermined confidentiality level from being reused.

In all the embodiments, when a confidentiality level of a sheet is higher than the set level, the sheet is stored in the confidential sheet cassette as a confidential sheet. However, a sheet may be stored in the confidential sheet cassette as a confidential sheet when the confidential level is the same as or higher than the set level.

In the first to third embodiments, even when a confidential sheet having a confidentiality level exceeding the predetermined level stored in the confidential sheet cassette is printed on one side and not printed on the other side, a printed side is not arranged. However, in the same manner as reversing the reuse sheet with, for example, the reversing mechanism shown in FIG. 2, it is also possible to arrange a printed side of a confidential sheet printed only on one side to the same direction such that the printed side is a lower side.

The first and second embodiments are explained on the premise that a sheet, both front and rear sides of which are not used, is not inserted into the apparatus. However, in an actual apparatus, such a both-side-unused sheet could be mixed. To prepare for such a case, it is also possible to provide one more cassette in the sheet storing unit as an unused sheet cassette.

In the first to third embodiments, the sheets are stored in the cassettes. However, the sheets do not always have to be stored in the cassettes in the present invention. In general, the sheets only have to be stored in the sheet storing unit.

While certain embodiments have been described, these embodiments have been presented by way of example only, and are not intended to limit the scope of the invention. Indeed, the novel methods and systems described herein may be embodied in a variety of other forms: furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A sheet sorting and storing apparatus comprising:
an ID recognizing unit configured to recognize a user ID for identifying a user;
a sheet storing unit including plural reuse sheet storing spaces each provided to correspond to the user ID recognized by the ID recognizing unit;
a sheet inserting unit into which a sheet is inserted;
a printing detecting unit configured to detect whether a front side and a rear side of the sheet inserted into the sheet inserting unit are printed; and
a sheet directing unit configured to direct, as a reuse sheet, a one-side-unused sheet detected by the printing detecting unit as not being printed on one of a front side and a rear side to the reuse sheet storing space corresponding to the user ID recognized by the ID recognizing unit and store the sheet in the reuse sheet storing space.

2. The apparatus according to claim 1, wherein
the printing detecting unit includes first and second printing detectors configured to respectively detect whether the front side and the rear side of the sheet inserted into the sheet inserting unit are printed, and
when printing is detected by only one of the two printing detectors, the apparatus stores, as a reuse sheet, the sheet in the reuse sheet storing space corresponding to the recognized user ID with an unused side arranged as an upper side or a lower side.

3. The apparatus according to claim 2, wherein the apparatus arranges, with a sheet reversing mechanism configured to reverse the front and rear sides of the sheet, the unused side according to one side on which printing is detected by the two printing detectors.

4. The apparatus according to claim 3, wherein the storing spaces further include a duplex printing sheet space in which, when printing is detected on both sides of a sheet by the two printing detectors, the sheet printed on both the sides is stored.

5. The apparatus according to claim 4, wherein the storing spaces further include a confidential sheet space in which a confidential sheet, at least printing of which is detected by the two printing detectors and a confidentiality indication level of which is detected, is stored.

6. The apparatus according to claim 5, wherein, when only one side of the sheet inserted into the sheet inserting unit is printed and the confidentiality indication level is recorded on the printed side, the apparatus stores only a sheet having the confidentiality indication level equal to or lower than a set level in the reuse sheet storing space corresponding to the recognized user ID.

7. The apparatus according to claim 6, wherein, when printing is detected on one side by the two printing detectors, the apparatus stores the sheet in the confidential sheet storing space with the other side, on which printing is not detected, as the upper side or the lower side.

8. The apparatus according to claim 7, wherein the apparatus arranges, with a sheet reversing mechanism configured to reverse front and rear sides of the confidential sheet, an unused side of the confidential sheet according to one side on which printing is detected by the two printing detectors.

9. The apparatus according to claim 8, wherein the reuse sheet stored in the reuse sheet storing space is supplied to a printing unit of an image forming apparatus connected to the apparatus.

10. A sheet sorting and storing apparatus comprising:
an ID recognizing unit configured to recognize a user ID for identifying a user;
a sheet storing unit including plural reuse sheet storing spaces each provided to correspond to the user ID recognized by the ID recognizing unit;
a sheet inserting unit into which a sheet is inserted;
a printing detecting unit configured to detect whether a front side and a rear side of the sheet inserted into the sheet inserting unit are printed;
a sheet directing unit configured to direct, as a reuse sheet, a one-side-unused sheet detected by the printing detecting unit as not being printed on one of a front side and a rear side to the reuse sheet storing space corresponding to the user ID recognized by the ID recognizing unit and store the sheet in the reuse sheet storing space; and
a printing unit configured to convey, when the user ID is specified and printing is instructed, a reuse sheet from the sheet storing space corresponding to the specified user ID and print the reuse sheet.

11. The apparatus according to claim 10, wherein
the printing detecting unit includes first and second printing detectors configured to respectively detect whether the front side and the rear side of the sheet inserted into the sheet inserting unit are printed, and
when printing is detected by only one of the two printing detectors, the apparatus stores, as a reuse sheet, the sheet in the reuse sheet storing space corresponding to the specified user ID with an unused side arranged as an upper side or a lower side.

12. The apparatus according to claim 11, wherein the apparatus arranges, with a sheet reversing mechanism configured to reverse the front and rear sides of the sheet, the unused side according to one side on which printing is detected by the two printing detectors.

13. The apparatus according to claim 12, wherein the storing spaces further include a sheet space in which, when printing is detected on both sides of a sheet by the two printing detectors, the duplex printing sheet printed on both the sides is stored.

14. The apparatus according to claim 13, wherein the storing spaces further include a confidential sheet storing space in which a confidential sheet, at least printing of which is detected by the two printing detectors and a confidentiality indication level of which is detected, is stored.

15. The apparatus according to claim 14, wherein, when the confidentiality indication level is recorded on the sheet inserted into the sheet inserting unit, the apparatus stores only a sheet having the confidentiality indication level equal to or lower than a set level in the reuse sheet storing space corresponding to the specified user ID.

16. The apparatus according to claim 15, wherein, when printing is detected on one side by the two printing detectors, the apparatus stores the sheet in the confidential sheet storing space with the other side, on which printing is not detected, as the upper side or the lower side.

17. The apparatus according to claim 16, wherein the apparatus arranges, with a sheet reversing mechanism configured to reverse front and rear sides of the confidential sheet, an unused side of the confidential sheet according to one side on which printing is detected by the two printing detectors.

18. A sheet sorting and storing method comprising:
recognizing a user ID for identifying a user;
detecting, when a sheet is inserted, whether a front side and a rear side of the inserted sheet are printed; and
directing, when printing is detected only on one side, as a reuse sheet, the one-side-unused sheet to a reuse sheet storing space corresponding to the user ID among plural reuse sheet storing spaces and storing the sheet in the reuse sheet storing space.

19. A sheet sorting and storing method comprising:
recognizing a user ID for identifying a user stored in an ID card;
detecting, in a printing detecting unit, whether a front side and a rear side of an inserted sheet inserted into a sheet inserting unit are printed; and
directing, as a reuse sheet, a one-side-unused sheet detected by the printing detecting unit as not being printed on one of a front side and a rear side to a reuse sheet storing space corresponding to the user ID among plural reuse sheet spaces and storing the sheet in the reuse sheet storing space with the unused side arranged as an upper side or a lower side.

20. The method according to claim 19, wherein the arrangement of the unused side of the unused sheet is performed by a sheet reversing mechanism according to a printed side detected by the printing detecting unit.
